(19) United States
(12) Patent Application Publication
(10) Pub. No.: US 2005/0139266 A1
(43) Pub. Date: Jun. 30, 2005

(54) Full-opening compact swing check valve

(76) Inventor: Jeffrey M. Partridge, Spring, TX (US)

Correspondence Address: WILLIAMS, MORGAN & AMERSON, P.C., 10333 RICHMOND, SUITE 1100, HOUSTON, TX, 77042, US

(21) Appl. No.: 11/009,172

(22) Filed: Dec. 10, 2004

Related U.S. Application Data
(60) Provisional application No. 60/528,783, filed on Dec. 11, 2003.

(51) Int. Cl. F16K 15/03

(52) U.S. Cl. 137/527.8

(57) ABSTRACT

A check valve includes a body defining a flow bore therethrough, a slot, and a cavity extending from the flow bore and a flapper shoe retained in the slot. The check valve further includes a flapper operatively mounted to the flapper shoe such that, when closed, flow is inhibited through the flow bore and, when opened, the flapper is completely received in the cavity. A check valve assembly includes a valve body defining a flow bore therethrough; a flapper operatively mounted within the valve body such that, when closed, flow is inhibited through the flow bore and, when opened, flow is uninhibited through the flow bore; and a tailpiece attached to the valve body, the tailpiece defining a flow bore therethrough in fluid communication with the flow bore of the valve body and defining a cavity extending from its flow bore for completely receiving the flapper when opened.

### CROSS REFERENCE TO RELATED APPLICATIONS

This application claims the benefit of U.S. Provisional Application No. 60/528,783, filed Dec. 11, 2003, which is hereby incorporated by reference in its entirety for all purposes.

### BACKGROUND OF THE INVENTION

1. Field of the Invention

This invention relates to a check valve. More specifically, the present invention relates to a check valve that can be fully opened.

2. Description of the Related Art

Compact manifold solutions, such as those used in oilfield operations, generally require compact valves. The overall length of a given valve with its weldable companion flanges is a significant determining factor in the overall size of a compact manifold. Swing check valves currently used in compact manifolds typically include two body penetrations in order to retain the flapper. Such body penetrations create undesirable potential leak paths.

Wafer-style swing check valves, such as a check valve 10 shown in FIG. 1-FIG. 2, have been used for many years. The wafer-style valve 10 is mounted between two standard flanges 12, 14, which have bores generally matching those of mating pipes 16, 18, respectively. The flange bore 20 (shown in phantom in FIG. 2) provides the cavity for a flapper 22 to swing open. This arrangement limits the size of the flapper 22, thereby limiting the size of the check valve bore 24. This reduced port, or valve bore 24, precludes pigging of the flowline, which is the running of a device (i.e., a pig) within a pipeline to clean the interior surfaces of the pipeline or to perform other operations on the pipeline. The reduced port or valve bore 24 also creates a generally undesired pressure drop across the valve 10 during flow. Existing wafer-style swing check valves employ such a construction.

Fully welded swing check valves, with all body joints or penetrations welded and the flowlines also connected by welding, are also available. Fully welded valves minimize the overall length of the valve and eliminate undesirable body penetrations, but do not allow for valve maintenance. The valve may only be removed from the flowline for service by cutting the flowline. Easy valve removal and maintenance with minimal disruption of the flowline is a requirement for compact manifold valves.

The present invention is directed to overcoming, or at least reducing, the effects of one or more of the problems set forth above.

### SUMMARY OF THE INVENTION

In one aspect of the present invention, a check valve is provided. The check valve includes a body defining a flow bore therethrough, a slot, and a cavity extending from the flow bore and a flapper shoe retained in the slot. The check valve further includes a flapper operatively mounted to the flapper shoe such that, when closed, flow is inhibited through the flow bore and, when opened, the flapper is completely received in the cavity.

In another aspect of the present invention, a check valve assembly is provided. The check valve assembly includes a valve body defining a flow bore therethrough and a flapper operatively mounted within the valve body such that, when closed, flow is inhibited through the flow bore and, when opened, flow is uninhibited through the flow bore. The check valve assembly further includes a tailpiece attached to the valve body, the tailpiece defining a flow bore therethrough in fluid communication with the flow bore of the valve body and defining a cavity extending from its flow bore for completely receiving the flapper when opened.

In yet another aspect of the present invention, a check valve assembly is provided. The check valve assembly includes a first flange defining a flow bore therethrough and a flapper operatively mounted within the first flange such that, when closed, flow is inhibited through the flow bore and, when opened, flow is uninhibited through the flow bore. The check valve assembly further includes a second flange attached to the valve body, the second flange defining a flow bore therethrough in fluid communication with the flow bore of the first flange and defining a cavity extending from its flow bore for completely receiving the flapper when opened.

In another aspect of the present invention, a valve assembly is provided. The valve assembly includes a valve defining a flow bore therethrough and a check valve wafer attached to the valve and defining a flow bore therethrough in fluid communication with the valve's flow bore such that, when the check valve wafer is in a closed state, flow is inhibited through the check valve flow bore and, when opened, flow is uninhibited through the check valve flow bore.

In yet another aspect of the present invention, a valve assembly is provided. The valve assembly includes a valve comprising a body defining a flow bore therethrough and a flapper operatively mounted within the body such that, when closed, flow is inhibited through the flow bore and, when opened, flow is uninhibited through the flow bore. The valve assembly further includes a tailpiece attached to the body, the tailpiece defining a flow bore therethrough in fluid communication with the flow bore of the body and defining a cavity extending from its flow bore for receiving the flapper when opened.

### BRIEF DESCRIPTION OF THE DRAWINGS

The invention may be understood by reference to the following description taken in conjunction with the accompanying drawings, in which like reference numerals identify like elements, and in which:

FIG. 1 is a side view of a conventional check valve;

FIG. 2 is a cross-sectional, side view of the check valve of FIG. 1;

FIG. 3 a partial, cross-sectional side view of one illustrative embodiment of a check valve assembly according to the present invention;

FIG. 4 is a partial, cross-sectional end view of the check valve assembly of FIG. 3 taken along the line 4-4 in FIG. 3;

FIG. 5 is an enlarged view of a portion of the view of FIG. 4;

FIG. 6 is a cross-sectional, side view of a first alternative illustrative embodiment of a check valve assembly according to the present invention;

FIG. 7 is cross-sectional, side view of a second alternative illustrative embodiment of a check valve assembly according to the present invention;

FIG. 8 is a cross-sectional, side view of a third alternative illustrative embodiment of a check valve assembly according to the present invention;

FIG. 9 is a partial, cross-sectional side view of a ball valve according to the present invention incorporating the check valve wafer of FIG. 3; and

FIG. 10 is a partial, cross-sectional side view of a ball valve according to the present invention incorporating the components of the check valve wafer of FIG. 3.

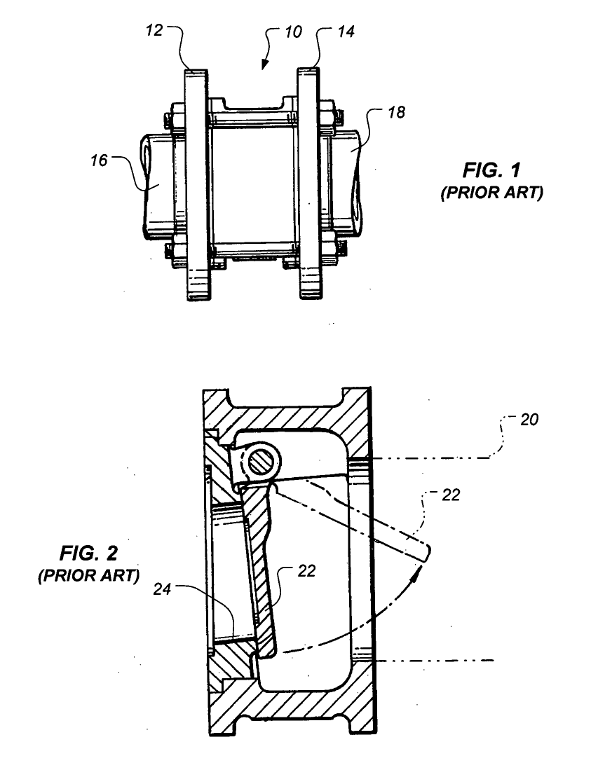

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In the specification, reference may be made to the direction of fluid flow between various components as the devices are depicted in the attached drawings. However, as will be recognized by those skilled in the art after a complete reading of the present application, the device and systems described herein may be positioned in any desired orientation. Thus, the reference to the direction of fluid flow should be understood to represent a relative direction of flow and not an absolute direction of flow. Similarly, the use of terms such as “above,” “below,” or other like terms to describe a spatial relationship between various components should be understood to describe a relative relationship between the components as the device described herein may be oriented in any desired direction.

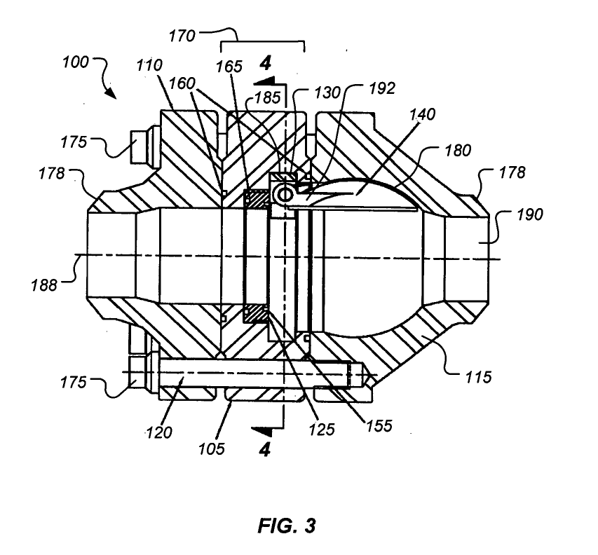

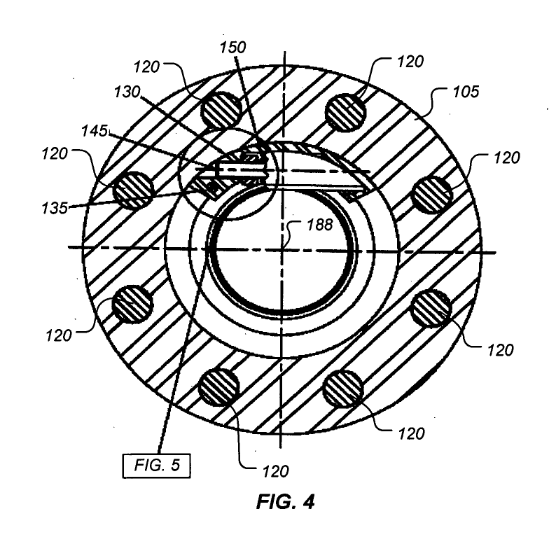

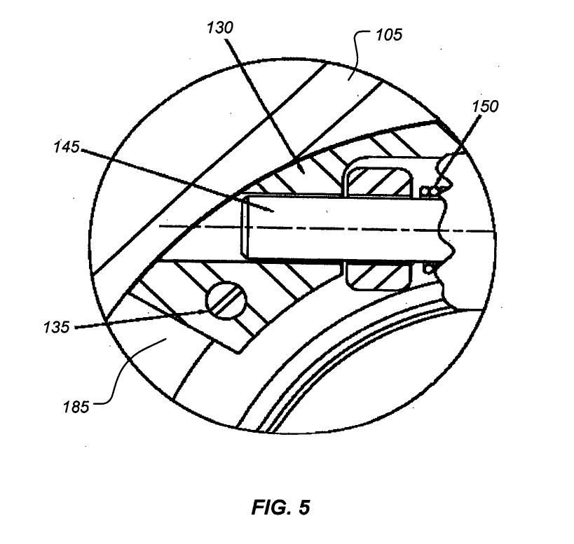

FIG. 3-FIG. 5 depict a first illustrative embodiment of a check valve assembly 100 according to the present invention. The check valve assembly 100 comprises a valve body 105 and an upstream flange 110, which are attached to downstream flange or tailpiece 115 via capscrews 120. The scope of the present invention, however, encompasses other ways of mechanically fastening the valve body 105 and the upstream flange 110 to the tailpiece 115. A valve seat 125 and a flapper shoe 130 are disposed within valve body 105. In the illustrated embodiment, the flapper shoe 130 is retained in the valve body 105 by setscrews 135 (shown in FIG. 4-FIG. 5), but may be retained by other means. A flapper 140 is hingedly mounted on the flapper shoe 130 via a flapper pin 145 (best shown in FIG. 4-FIG. 5), which may comprise part of the flapper 140 or may be a separate element. In some embodiments, the flapper 140 is biased towards a closed position against the valve seat 125, via a flapper spring 150 (best shown in FIG. 5). The flapper spring 150, however, may be omitted in some embodiments. In the illustrated embodiment, one or more seals 155 are provided on the valve seat 125 for sealing between the valve seat 125 and the flapper 140 when the flapper 140 is closed. Alternatively, the one or more seals 155 may be provided on the flapper 140 or may be omitted altogether. O-ring flange seals 160 are provided between the valve body 105 and the upstream flange 110, as well as between the valve body 105 and the tailpiece 115. One or more O-ring seals 165 are provided between valve seat 125 and valve body 105. Sealing elements other than O-rings, however, may be used at any of these sealing locations.

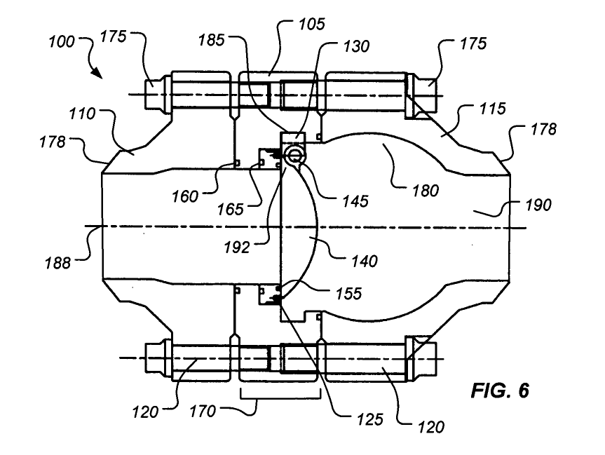

The function of the valve of the present invention is to prevent flow in one direction while allowing flow in the other direction. The flapper 140 swings open when flow moves from left to right (as depicted in FIG. 3) and swings closed when flow reverses (as shown in FIG. 6). The flapper spring 150, when present, urges the flapper 140 toward a closed position because the center of gravity of the flapper 140 may be upstream of the flapper pin 145 when the flapper 140 is in its closed position. The valve assembly 100 comprises the upstream flange 110, a valve wafer 170, and the tailpiece 115. In the illustrated embodiment, the valve wafer 170, in turn, comprises the valve body 105, the valve seat 125, the flapper 140, the flapper shoe 130, the flapper pin 145, the flapper spring 150, and the setscrews 135. As noted above, in the illustrated embodiment, the upstream flange 110, the valve wafer 170, and the tailpiece 115 are connected by capscrews 120. Alternatively, the upstream flange 105, the valve wafer 170, and the tailpiece 115 may be connected by studs extending from either the upstream flange 105, the valve body 105, or the tailpiece 115 and nuts (not shown). In the illustrated embodiment, the bolts or screws 120 may be installed with their fastener heads 175 adjacent the upstream flange 110 or the tailpiece 115. The bolts or screws 120 may pass through clearance holes in the valve body 105, as shown, or be installed in threaded holes in the valve body 105 and pass through clearance holes in the upstream flange 110 and tailpiece 115, as illustrated in FIG. 6.

The complete valve assembly 100, as illustrated in FIG. 3-FIG. 6, is designed such that it may be welded into a flowline, such that the valve assembly can be serviced by removing the capscrews 120 and sliding the valve body 105 and its internal components (i.e., the valve wafer 170) out from between the upstream flange 110 and the tailpiece 115. Having the three separate pieces (i.e., the upstream flange 105, the valve wafer 170, and the tailpiece 115) allows the placement of all sensitive items, such as seals, within the valve body 105, which is generally not present at the time of welding. In the illustrated embodiment, the upstream flange 110 and the tailpiece 115 are single components that do not include items sensitive to the heat of welding or stress-relieving. The upstream flange 110 and tailpiece 115 may include weld preparations (e.g., bevels 178, grooves, etc.) that are ready for welding to the mating pipe.

In the embodiments illustrated in FIG. 3-FIG. 6, the tailpiece 115 also defines a cavity 180 that accepts the flapper 140 when it is in its fully-opened position. This allows the flapper 140 to swing fully out of the flow path, minimizing the pressure drop across the valve, and eliminating interference with operations such as pigging. Note that, while the cavity 180 is illustrated in the accompanying figures as extending radially around the entire flow bore 190, concentric with the center line 188, the present invention is not so limited. Rather, the cavity 180 may be sized only to completely contain the flapper 140 when in its fully-opened position.

The valve seat 125 may be integral with the valve body 105 or may be replaceable, as shown. In the event the valve seat 125 is integral with the valve body 105, the seat to body seal 165 is omitted. Note that the valve seat 125 does not contribute to sealing the valve shell (i.e., to prevent external leakage from or to the valve assembly 100) but only serves a sealing function when the valve assembly 100 is closed. When flow reverses and the valve assembly 100 closes, the flapper 140 contacts the seat 125 and seals through the seat to flapper seal 155. The seat 125 seals to the valve body 105 through the seat to body seal 165. The flapper 140 pivots about the flapper pin 145. The flapper pin 145 is rotatably retained by the flapper shoe 130. The optional spring 150 assists the flapper 140 by providing a closing moment that biases the flapper towards the closed position.

The flapper shoe 130 and its mating slot in the valve body 105 provide a simple means for retaining the flapper pin 145 without making body pressure-boundary penetrations. In the illustrated embodiment, the flapper shoe 130 comprises a portion of a ring that fits in an internal groove 185 defined by the valve body 105. The flapper shoe 130 is restrained from moving radially outwardly, upstream, or downstream by the groove 185. The flapper shoe 130 is restrained from movement radially inwardly or tangentially about the valve centerline 188 by the setscrews 135. The setscrews 135 may be threaded through the flapper shoe 130 and into blind holes in the valve body 105. Setscrews, capscrews, pins, keys, or other such locking devices may be used to serve the same purpose as the setscrews 135. By preventing radially inward movement, the setscrews 135 keep the flapper shoe 130 from becoming dislodged.

The setscrews 135 fit completely inside a theoretical circle having its center at the center of the flow bore 190 (i.e., at the valve centerline 188) and passing just outboard of flapper arms 192 when the flapper 140 is in its fully-opened position. By keeping the flapper shoe locking means (e.g., the setscrews 135) inside this circle, the sealing diameter of the tailpiece connection (i.e., the connection between the valve wafer 170 and the tailpiece 115) is minimized. Keeping this sealed opening as small as possible is significant because the total bolt strength required for the connection is directly determined by the sealed diameter of this joint. A larger opening would require more or larger capscrews 120, causing the outer diameter of the assembly to become larger.

By placing the downstream connection close to the flapper pin 145, the overall length of the valve body 105 is minimized. The length of the tailpiece 115 is generally slightly longer than a comparable, conventional weldneck flange. The result is the shortest complete valve assembly (i.e., upstream flange 110, valve wafer 170, and tailpiece 115) that is suitable for welding in-line, and also allows easy maintenance and provides a full-opening flapper 140 suitable for pigging and other full-bore operations. Placing the downstream connection (i.e., the connection between the valve wafer 170 and the tailpiece 115) adjacent the flapper pin 145 also allows easier machining access for detail machining of the holes to accept the setscrews 135. These holes would be much more difficult to machine, if not impractical, if the downstream connection were smaller and further downstream.

In total, there are two seals in the illustrated embodiment to prevent external leakage, compared to five on some existing valves. The two body penetrations required for installing the flapper pin in existing designs have been completely eliminated in the present invention. A third seal is eliminated by placing the replaceable valve seat 125 completely inside the valve body 105, whereas some existing valve designs have a seal, disposed between the valve body and valve seat, that is exposed to the valve external environment. The combined length of the valve body 105 and the tailpiece 115 is very nearly the length of conventional valve bodies alone in existing compact swing check valves. In some embodiments, the upstream flange 105 is generally unchanged from that of existing valves.

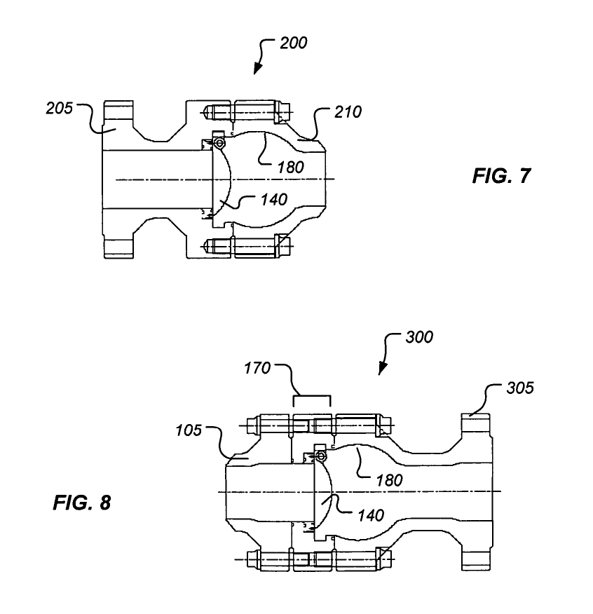

While the embodiments illustrated in FIG. 3 and FIG. 6 comprise upstream flanges 110 and tailpieces 115 adapted to be welded to sections of pipe, such as in a pipeline, the present invention is not so limited. Rather, embodiments of the present valve assembly may be flange-bolted or otherwise mechanically fastened to piping sections. Moreover, the valve wafer 170 of FIG. 3 and FIG. 6 may be incorporated into either an upstream flange or a tailpiece. FIG. 7 depicts one such embodiment according to the present invention, wherein a valve assembly 200 comprises an upstream flange 205 attached directly to a tailpiece 110. In this embodiment, the components of the valve wafer 170 (i.e., the valve body 105, the valve seat 125, the flapper 140, the flapper shoe 130, the flapper pin 145, the flapper spring 150, and the setscrews 135 of FIG. 3-FIG. 5) are incorporated into the upstream flange 205 and operate in the same manner as discussed above. The tailpiece 110 of FIG. 7 defines the cavity 180 for receiving the flapper 140 when in the open position and is configured to be welded to a piping section. The upstream flange 205 is adapted to be bolted to a piping or other flow section. Alternatively, the tailpiece 110 may be configured to be flange-bolted to a piping or other flow section.

FIG. 8 depicts another illustrative embodiment of a valve assembly 300 according to the present invention. This embodiment generally corresponds to that of FIG. 3 and FIG. 6, except that the tailpiece 305 is adapted to be flange-bolted to a piping or other flow section, rather than being welded to a piping section. Alternatively, the upstream flange 105 may be configured to be flange-bolted and, in some embodiments, may incorporate the components of the valve wafer 170 therein.

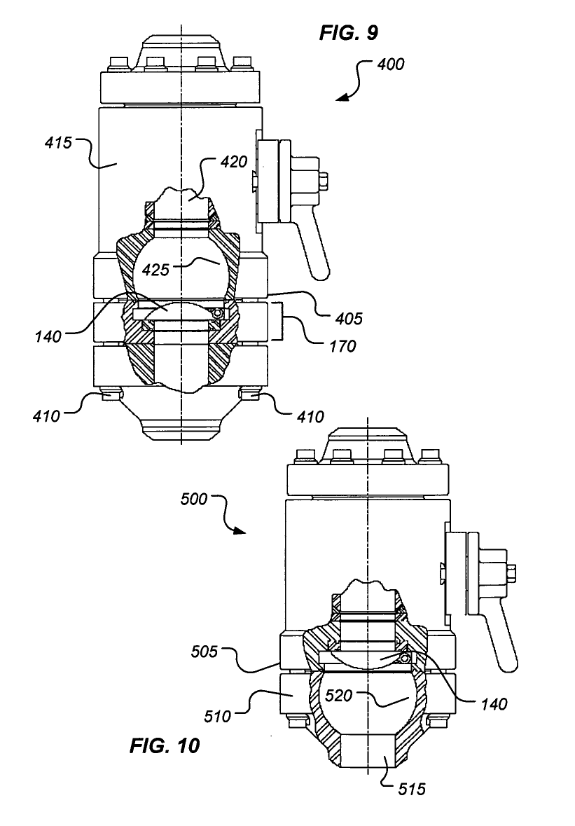

The embodiments discussed to this point have been generally directed to a stand-alone check valve, in that the check valve assemblies 100, 200, 300 are not shown in combination with other flow control devices. The present invention, however, is not so limited. Rather, the valve wafer 170 may be incorporated with other valve assemblies or other flow control assemblies. FIG. 9-FIG. 10 illustrate the valve wafer 170 incorporated into ball valves 400, 500. For example, as shown in FIG. 9, the valve wafer 170 is attached an inlet flange 405 of the ball valve 400. Note that the inlet flange 405 may be adapted to receive fastening members (e.g., bolts 410 or the like) or it may comprise studs extending therefrom for attaching the valve wafer 170 thereto. In the illustrated embodiment, a body 415 of the ball valve 400 defines a bore 420 that includes a cavity 425 for receiving the flapper 140 when in its open position.

Alternatively, as depicted in FIG. 10, components of the valve wafer 170 may be incorporated into an output side 505 of the ball valve 500 in the same way that the components of the valve wafer 170 are incorporated into the upstream flange 205 of FIG. 7. In this embodiment, a tailpiece 510 defines a bore 515 including a cavity 520 for receiving the flapper 140 when in its open position. Alternatively, the valve wafer 170 may be attached to the output side of the ball valve 500, rather than being incorporated therein.

While FIG. 9-FIG. 10 illustrate ball valves 400, 500 comprising the valve wafer 170 or the components of the valve wafer 170 incorporated therein, the present invention is not so limited. Rather, the scope of the present invention encompasses the valve wafer 170, or the components thereof, in combination with various types of flow devices, such as other types of valves, wellhead fittings, tees, elbows, crosses, pipe connectors, pressure vessels, pig launchers, pig receivers, flow headers, and the like.

In one particular embodiment of the present invention, a check valve includes a body defining a flow bore therethrough, a slot, and a cavity extending from the flow bore and a flapper shoe retained in the slot. The check valve further includes a flapper operatively mounted to the flapper shoe such that, when closed, flow is inhibited through the flow bore and, when opened, the flapper is completely received in the cavity.

In another particular embodiment of the present invention, a check valve assembly includes a valve body defining a flow bore therethrough and a flapper operatively mounted within the valve body such that, when closed, flow is inhibited through the flow bore and, when opened, flow is uninhibited through the flow bore. The check valve assembly further includes a tailpiece attached to the valve body, the tailpiece defining a flow bore therethrough in fluid communication with the flow bore of the valve body and defining a cavity extending from its flow bore for completely receiving the flapper when opened.

In yet another particular embodiment of the present invention, a check valve assembly includes a first flange defining a flow bore therethrough and a flapper operatively mounted within the first flange such that, when closed, flow is inhibited through the flow bore and, when opened, flow is uninhibited through the flow bore. The check valve assembly further includes a second flange attached to the valve body, the second flange defining a flow bore therethrough in fluid communication with the flow bore of the first flange and defining a cavity extending from its flow bore for completely receiving the flapper when opened.

In another particular embodiment of the present invention, a valve assembly includes a valve defining a flow bore therethrough and a check valve wafer attached to the valve and defining a flow bore therethrough in fluid communication with the valve's flow bore such that, when the check valve wafer is in a closed state, flow is inhibited through the check valve flow bore and, when opened, flow is uninhibited through the check valve flow bore.

In yet another particular embodiment of the present invention, a valve assembly includes a valve comprising a body defining a flow bore therethrough and a flapper operatively mounted within the body such that, when closed, flow is inhibited through the flow bore and, when opened, flow is uninhibited through the flow bore. The valve assembly further includes a tailpiece attached to the body, the tailpiece defining a flow bore therethrough in fluid communication with the flow bore of the body and defining a cavity extending from its flow bore for receiving the flapper when opened.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A check valve, comprising:
a body defining a flow bore therethrough, a slot, and a cavity extending from the flow bore;
a flapper shoe retained in the slot; and
a flapper operatively mounted to the flapper shoe such that, when closed, flow is inhibited through the flow bore and, when opened, the flapper is completely received in the cavity.

2. A check valve, according to claim 1, further comprising a flapper pin extending through the flapper and into the flapper shoe.

3. A check valve, according to claim 11, wherein the flapper comprises a flapper pin extending into the flapper shoe.

4. A check valve, according to claim 1, further comprising a locking device, such that the flapper shoe is retained in the slot by the locking device.

5. A check valve, according to claim 1, further comprising a valve seat, disposed within the body, on which the flapper seats when closed.

6. A check valve, according to claim 5, further comprising a flapper seal disposed on one of the valve seat and the flapper for sealing between the flapper and the valve seat when the flapper is closed.

7. A check valve, according to claim 5, wherein the valve seat is removable from the body.

8. A check valve assembly, comprising:
a valve body defining a flow bore therethrough;
a flapper operatively mounted within the valve body such that, when closed, flow is inhibited through the flow bore and, when opened, flow is uninhibited through the flow bore; and
a tailpiece attached to the valve body, the tailpiece defining a flow bore therethrough in fluid communication with the flow bore of the valve body and defining a cavity extending from its flow bore for completely receiving the flapper when opened.

9. A check valve assembly, according to claim 8, wherein the valve body defines a slot, the check valve assembly further comprising a flapper shoe retained within the slot, such that the flapper is operatively mounted to the flapper shoe.

10. A check valve assembly, according to claim 9, further comprising a flapper pin extending through the flapper and into the flapper shoe.

11. A check valve assembly, according to claim 9, wherein the flapper comprises a flapper pin that extends into the flapper shoe.

12. A check valve assembly, according to claim 9, further comprising a locking device, such that the flapper shoe is retained in the slot by the locking device.

13. A check valve assembly, according to claim 8, further comprising a valve seat, disposed within the valve body, on which the flapper seats when closed.

14. A check valve assembly, according to claim 13, further comprising a flapper seal disposed on one of the valve seat and the flapper for sealing between the flapper and the valve seat when the flapper is closed.

15. A check valve assembly, according to claim 13, wherein the valve seat is removable from the valve body.

16. A check valve assembly, according to claim 8, wherein the tailpiece is adapted to be welded to a pipe.

17. A check valve assembly, according to claim 8, wherein the tailpiece is adapted to be mechanically fastened to a flange.

18. A check valve assembly, according to claim 8, further comprising an upstream flange attached to the valve body and defining a flow bore in fluid communication with the flow bore of the valve body.

19. A check valve assembly, comprising:
a first flange defining a flow bore therethrough;
a flapper operatively mounted within the first flange such that, when closed, flow is inhibited through the flow bore and, when opened, flow is uninhibited through the flow bore; and
a second flange attached to the valve body, the second flange defining a flow bore therethrough in fluid communication with the flow bore of the first flange and defining a cavity extending from its flow bore for completely receiving the flapper when opened.

20. A check valve assembly, according to claim 19, wherein the valve body defines a slot, the check valve assembly further comprising a flapper shoe retained within the slot, such that the flapper is operatively mounted to the flapper shoe.

21. A check valve assembly, according to claim 20, further comprising a flapper pin extending through the flapper and into the flapper shoe.

22. A check valve assembly, according to claim 20, wherein the flapper comprises a flapper pin that extends into the flapper shoe.

23. A check valve assembly, according to claim 20, further comprising a locking device, such that the flapper shoe is retained in the slot by the locking device.

24. A check valve assembly, according to claim 19, further comprising a valve seat, disposed within the first flange, on which the flapper seats when closed.

25. A check valve assembly, according to claim 24, further comprising a flapper seal disposed on one of the valve seat and the flapper for sealing between the flapper and the valve seat when the flapper is closed.

26. A check valve assembly, according to claim 24, wherein the valve seat is removable from the first flange.

27. A check valve assembly, according to claim 19, wherein the first flange comprises an upstream flange and the second flange comprises a tailpiece.

28. An assembly, comprising:
a flow device defining a flow bore therethrough; and
a check valve wafer attached to the flow device and defining a flow bore therethrough in fluid communication with the flow device's flow bore such that, when the check valve wafer is in a closed state, flow is inhibited through the check valve flow bore and, when opened, flow is uninhibited through the check valve flow bore.

29. An assembly, according to claim 28, wherein the flow device comprises one of a valve, a wellhead fitting, a tee, an elbow, a cross, a pipe connector, a pressure vessel, a pig launcher, a pig receiver, and a flow header.

30. An assembly, according to claim 28, wherein the flow device comprises a body defining the flow device flow bore and further defining a cavity extending from the flow device flow bore, such that the flapper is completely received in the cavity when opened.

31. An assembly, according to claim 28, wherein the check valve wafer comprises:
a check valve body defining the check valve wafer flow bore; and
a flapper operatively mounted within the check valve body such that, when closed, flow is inhibited through the check valve wafer flow bore and, when opened, flow is uninhibited through the check valve wafer flow bore.

32. An assembly, according to claim 31, wherein the check valve body defines a slot, the check valve wafer further comprising a flapper shoe retained within the slot, such that the flapper is operatively mounted to the flapper shoe.

33. An assembly, according to claim 32, further comprising a flapper pin extending through the flapper and into the flapper shoe.

34. An assembly, according to claim 32, wherein the flapper comprises a flapper pin that extends into the flapper shoe.

35. An assembly, according to claim 32, further comprising a locking device, such that the flapper shoe is retained in the slot by the locking device.

36. An assembly, comprising:
a flow device comprising a body defining a flow bore therethrough;
a flapper operatively mounted within the body such that, when closed, flow is inhibited through the flow bore and, when opened, flow is uninhibited through the flow bore; and
a tailpiece attached to the body, the tailpiece defining a flow bore therethrough in fluid communication with the flow bore of the body and defining a cavity extending from its flow bore for receiving the flapper when opened.

37. An assembly, according to claim 36, wherein the flapper is completely received into the cavity when in its fully opened position.

38. An assembly, according to claim 36, wherein the flow device comprises one of a valve, a wellhead fitting, a tee, an elbow, a cross, a pipe connector, a pressure vessel, a pig launcher, a pig receiver, and a flow header.

39. An assembly, according to claim 36, wherein the body defines a slot, the assembly further comprising a flapper shoe retained within the slot, such that the flapper is operatively mounted to the flapper shoe.

40. An assembly, according to claim 39, further comprising a flapper pin extending through the flapper and into the flapper shoe.

41. An assembly, according to claim 39, wherein the flapper comprises a flapper pin that extends into the flapper shoe.

42. An assembly, according to claim 39, further comprising a locking device, such that the flapper shoe is retained in the slot by the locking device.
